(19) United States
(12) Patent Application Publication
(10) Pub. No.: US 2025/0021918 A1
(43) Pub. Date: Jan. 16, 2025

(54) Business Creation Based on Prioritized Feature Sets

(71) Applicant: Bank of America Corporation, Charlotte, NC (US)

(72) Inventors: Shola L. Oni, Atlanta, GA (US); Jinna Kim, Charlotte, NC (US); Jo-Ann Taylor, Godalming (GB); Vijaya L. Vemireddy, Plano, TX (US)

(73) Assignee: Bank of America Corporation, Charlotte, NC (US)

(21) Appl. No.: 18/222,074

(22) Filed: Jul. 14, 2023

(51) Int. Cl. G06Q 10/067; G06Q 10/0631; G06Q 10/0637

(52) U.S. Cl. CPC G06Q 10/067; G06Q 10/06315; G06Q 10/0637

(57) ABSTRACT

A computing platform to generate and manage businesses for users. An artificial intelligence/machine learning (AI/ML) model is continually trained to identify user interests and hobbies that may be transformed into business ventures. The computing platform aggregates electronic data about activities or transactions performed via applications computing systems providing products or services to users. The computing platform facilitates generation of a new business based on prioritized feature sets. The AIMI generates and creates management tools such as business plans that include financial plans, marketing plans, human resource plans, competitor environment analysis, and other management tools for successful operation of the new business.

### BACKGROUND

Large organizations, such as financial institutions and other large enterprise organizations, may provide many different products and/or services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization to provide and/or support different products and services offered by the organization. In providing services, these organizations may maintain one or more data repositories of information relating to the various services, and/or users of the various services, that may be offered by the organizations. In some cases, a user of the services provided by the organization may have specialized expertise, interests, hobbies, and/or skills and may desire assistance in forming a business based on their specialized expertise, interests, hobbies and/or skills. In many instances, users do not know where to begin to open a business venture. As such, the need has been recognized to provide a business generation and management system to assist these users in generating and operating new business ventures.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure address one or more of the shortcomings of the industry by providing a computing platform to generate and manage businesses for users. An artificial intelligence/machine learning (AI/ML) model is continually trained to identify user interests and hobbies that may be transformed into business ventures. The computing platform aggregates electronic data about activities or transactions performed via applications computing systems providing products or services to users. The computing platform facilitates generation of a new business based on prioritized feature sets. The AI/MI generates and creates management tools such as business plans that include financial plans, marketing plans, human resource plans, competitor environment analysis, and other management tools for successful operation of the new business.

Aspects of the disclosure relate to computer hardware and software. In particular, one or more aspects of the disclosure generally relate to computer hardware and software for processing electronic data records to identify patterns of activity via, for example, a machine learning model to develop and generate business tools based on electronic activities of users of products and services of an enterprise network and assist these uses in opening and operating new business venture once formed.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The enterprise organization may mine electronic data records from electronic activities performed via one or more application computing systems providing products or services to users. An artificial intelligence/machine learning (AI/ML) model may be continually trained to identify users' interests. These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for business generation and management of the generated business, in accordance with one or more aspects described herein;

FIG. 1B shows an illustrative computing platform enabled for business generation and management of the generated business, in accordance with one or more aspects described herein; and

FIG. 2 shows an illustrative method of business generation in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

The enterprise organization may mine electronic data records from electronic activities performed via one or more application computing systems providing products or services to users. An artificial intelligence/machine learning (AI/ML) model may be continually trained to identify user interests and generate business models based on the identified user interests. Users may provide information about interests, talents, business focus, or the like, and/or information may be obtained from internal and/or external data. The system can connect people with similar interests (e.g., as identified using ML/AI, data analysis, etc.) or people who could benefit from being connected (e.g., a philanthropist, a grant writer, etc.). The AI/ML model may identify or anticipate a user's needs (e.g., financial needs) and connect users with other users who may be able to assist, and/or trigger application computing systems to communicate targeted recommendations for certain products or services. In some examples, the AI/ML model may connect creative people with business-focused people who can help launch a business and/or may trigger communication of offers that provide options for benefits that may be targeted to particular users' passions, assist with crowd-sourced funding, and the like. In further examples, the AI/ML model may determine and analyze potential grant offers a user may be eligible for and assist the user in applying for and obtaining determined grant opportunities.

The AI/ML model may create feature sets from all the collected and analyzed data and generate business models based on the data. The generated business models may be transmitted to a user for use in assisting a user in generating a new business venture. The AI/ML model after business model selection may generate and auto populate government forms for business incorporation for a new business venture in the state or states of user selection. The AI/ML model may generate and open a new financial business account for the new business venture along with generation of exemplary business and operating plans based on the type of new business venture. For instance, the AI/ML model may assist the user with selecting the appropriate type of business account and credit limit based on analyzed data and type of new business venture. The business account may include determination and selection of credit cards or other financial instruments based on business needs.

The AI/ML model may provide website creation and determine appropriate advertising channels for the new business venture. In an embodiment, the AI/ML model may generate tax forms or other business-related government required reporting forms based on type and geographical location of the new business venture.

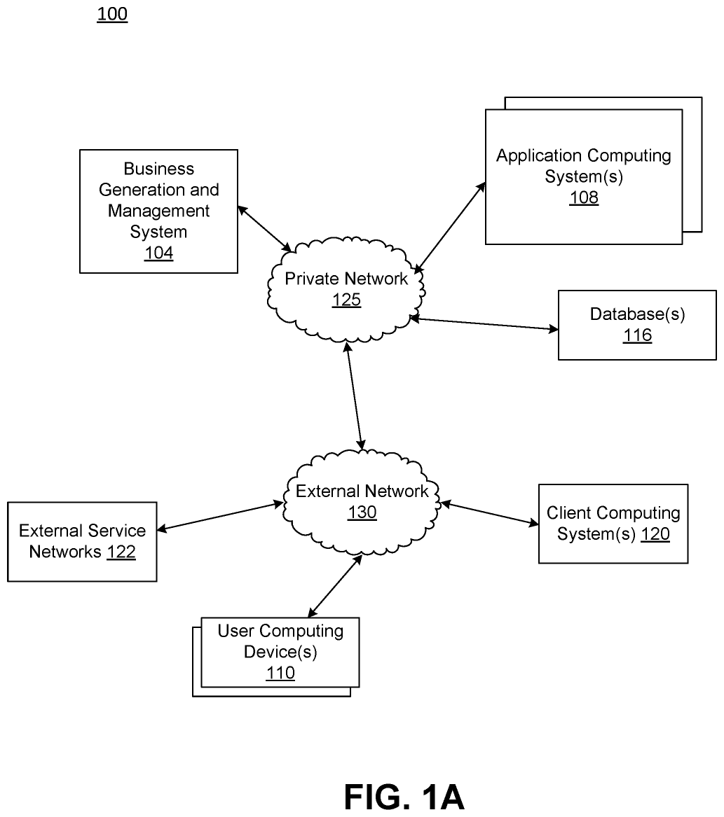

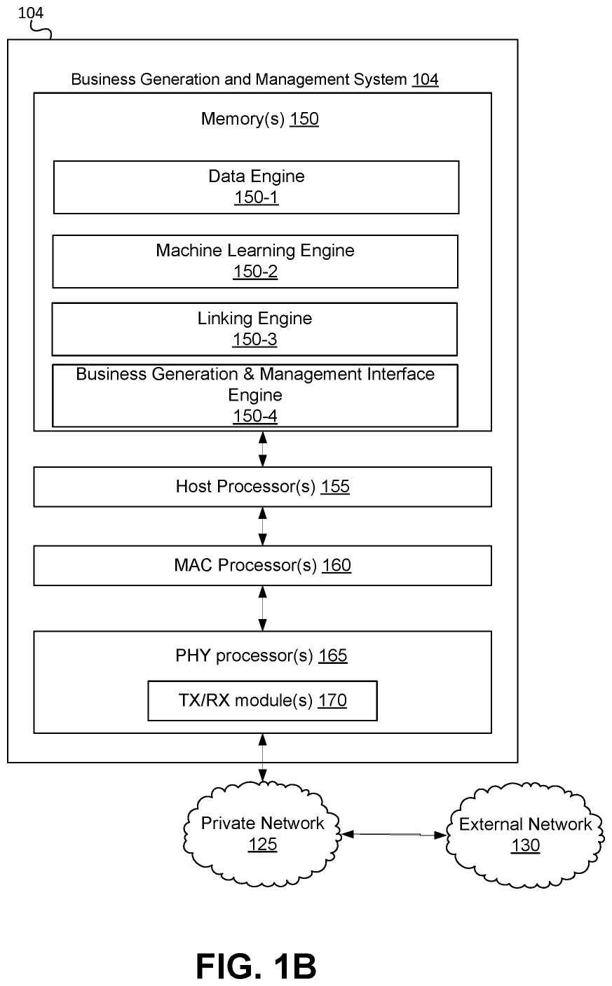

FIG. 1A shows an illustrative computing environment 100 for business generation and management of the generated business in accordance with one or more arrangements. The computing environment 100 may comprise one or more devices (e.g., computer systems, communication devices, and the like). The computing environment 100 may comprise, for example, a business generation and management system 104, one or more application system 108, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise a client computing system 120 and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3rd Generation Partnership Project (3GPP) cellular protocol, a hypertext transfer protocol (HTTP), etc.). While FIG. 1A shows the business generation and management system 104 as a separate computing system, but may be incorporated within multiple computing systems.

The business generation and management system 104 may comprise one or more computing devices and/or other computer components (e.g., processors, memories, communication interfaces) configured to perform one or more functions as described herein. Further details associated with the architecture of the business generation and management system 104, are described with reference to FIG. 1B.

The application computing systems 108 and/or external service networks 122 may comprise one or more computing devices and/or other computer components (e.g., processors, memories, communication interfaces). In addition, the application computing systems 108 and/or the external service networks 122 may be configured to host, execute, and/or otherwise provide one or more enterprise applications. In some cases, the application computing systems 108 and/or the external service networks 122 may host one or more services configured facilitate operations requested through one or more API calls, such as data retrieval and/or initiating processing of specified functionality. In some cases, the external service networks 122 may be configured to communicate with one or more of the application computing systems 108 such as via direct communications and/or API function calls and the services. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The application systems 108 and/or the external service networks 122 may comprise various servers and/or databases that store and/or otherwise maintain account information, such as financial account information including account balances, transaction history, account owner information, and/or other information. In addition, application systems 108 and/or the external service networks 122 may process and/or otherwise execute transactions on specific accounts based on commands and/or other information received from other computer systems comprising the computing environment 100. In some cases, one or more of application computing systems 108 and/or the external service networks 122 may be configured, for example, to host, execute, and/or otherwise provide one or more transaction processing programs, such as electronic fund transfer applications, online loan processing applications, and/or other programs associated with the financial institution. Additionally, or alternatively, the external service networks 122 may include one or more public or private service networks accessible to users via their user computing devices 110 via the external network 130. Such external service networks 122 may include one or more social networks, bulletin boards, specialty online communities that may align with one or more interests of the users, including, but not limited to, creative activities (e.g., art appreciation, art creation, painting, musical appreciation, musical performance, creative writing, literary writing, sculpting, sporting activities, and the like). Such external service networks 122 may allow users to interact with other individuals sharing same or similar interests, wherein the individuals may have the same or different levels of expertise. Being online public communities, often users can't rely upon advice of other individuals since the veracity or accuracy of advice, opinions, and the like cannot be verified easily.

The application computing systems 108 may be one or more host devices (e.g., a workstation, a server, and the like) or mobile computing devices (e.g., smartphone, tablet). In addition, an application computing systems 108 may be linked to and/or operated by a specific enterprise user (who may, for example, be an employee or other affiliate of the enterprise organization) who may have administrative privileges to perform various operations within the private network 125. In some cases, the application computing system 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing system 120 may comprise one or more computing devices and/or other computer components (e.g., processors, memories, communication interfaces). The client computing system 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing system 120 is for processing an electronic exchange of goods and/or services. The client computing system 120 may be associated with a specific goods purchasing activity, such as purchasing a vehicle, transferring title of real estate may perform communicate with one or more other platforms within the client computing system 120. In some cases, the client computing system 120 may integrate API calls to request data, initiate functionality, or otherwise communicate with the one or more application computing systems 108, such as via the services. For example, the services may be configured to facilitate data communications (e.g., data gathering functions, data writing functions, and the like) between the client computing system 120 and the one or more application computing systems 108.

The user device(s) 110 may be computing devices (e.g., desktop computers, laptop computers) or mobile computing devices (e.g., smartphones, tablets) connected to the network 125. The user device(s) 110 may be configured to enable the user to access the various functionalities provided by the devices, applications, and/or systems in the network 125.

The database(s) 116 may comprise one or more computer-readable memories storing information that may be used by the business generation and management system 104. For example, the database(s) 116 may store user hobby information, user associations, activity identification information, skill level information, expertise information, creative activity information, and the like. In an arrangement, the database(s) 116 may be used for other purposes as described herein. In some cases, the client computing system 120 may write data or read data to the database(s) 116 via the services.

In one or more arrangements, business generation and management system 104, the application computing systems 108, the client computing system 120, the external service networks 122, the user devices 110, and/or the other devices/systems in the computing environment 100 may be any type of computing device capable of receiving input via a user interface, and communicating the received input to one or more other computing devices in the computing environment 100. For example, business generation and management system 104, the application computing systems 108, the client computing system 120, the external service networks 122, the user devices 110, and/or the other devices/systems in the computing environment 100 may, in some instances, be and/or include server computers, desktop computers, laptop computers, tablet computers, smart phones, wearable devices, or the like that may comprise of one or more processors, memories, communication interfaces, storage devices, and/or other components. Any and/or all of the business generation and management system 104, the application computing systems 108, the client computing system 120, the external service networks 122, the user devices 110, and/or the other devices/systems in the computing environment 100 may, in some instances, be and/or comprise special-purpose computing devices configured to perform specific functions.

FIG. 1B shows an illustrative business generation and management system 104 in accordance with one or more examples described herein. The business generation and management system 104 may be a stand-alone device and/or may at least be partial integrated with the development computing system 104 may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The business generation and management system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the business generation and management system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUS)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 125. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the business generation and management system 104 may be configured to execute machine readable instructions stored in memory 150. The memory 150 may comprise (i) one or more program modules/engines having instructions that when executed by the one or more processors cause the business generation and management system 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the business generation and management system 104 and/or by different computing devices that may form and/or otherwise make up the business generation and management system 104. For example, the memory 150 may have, store, and/or comprise a data engine 150-1, a machine learning engine 150-2, a linking engine 150-3, an interface engine 150-4, and/or the like. The data engine 150-1 may have instructions that direct and/or cause the business generation and management system 104 to perform one or more operations associated with aggregating and grouping data from a plurality of sources including the application computing systems 108, the databases 116, the external service networks 122, and the like. The machine learning engine 150-2 may have instructions that may cause the business generation and management system 104 to automatically train and manage machine learning or other artificial intelligence models to analyze data aggregated and/or processed by the data engine 150-1, where the models may identify user interests such as hobbies or other activities (e.g., art appreciation, art creation, painting, musical appreciation, musical performance, creative writing, literary writing, sculpting, sporting activities, and the like) that may be candidates for turning into new business ventures. The machine learning engine 150-2 may be retained based on feedback received via user interface queries and/or analysis of additional operations or transactions performed by the user. The machine learning engine 150-2 may have instructions that may cause the business generation and management system 104 to manage operation of the newly generated business venture and automatically develop business plans and associated documents for the new business venture. The linking engine 150-3 may have instructions that may cause business generation and management system 104 to link the user to other users or organizations that may assist in generating a new business venture or in management of the new business venture.

While FIG. 1A illustrates business generation and management system 104 and/or the application computing systems 108, as being separate elements connected in the private network 125, in one or more other arrangements, functions of one or more of the above may be integrated in a single device/network of devices. For example, elements in business generation and management system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the application computing systems 108.

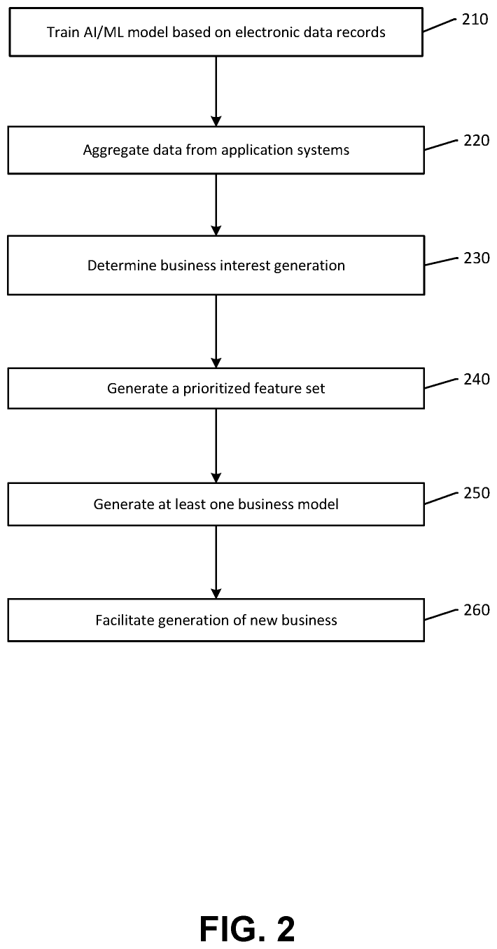

FIG. 2 shows an illustrative method for generating and managing a new business venture in accordance with one or more aspects described herein. At 210, the machine learning engine 150-2 may train one or more AI/ML models based on electronic data records to identify one or more interests of a user that may be the basis for a new business. The electronic data record may include historical transaction data of users. The transaction data may include goods, services and activities associated with a profession, a vocation, a hobby, or the like. Additionally, the model may analyze the activities to determine an experience that each user has for each creative interest, such as to identify whether the user is proficient (e.g., an expert), is learning, or somewhere in between. In some cases, the historical data may be previously aggregated by the data engine 150-1 from one or more data sources, such as the databases 116, the application computing systems 108, and/or one or more of the external service networks 122.

Further, data engine 150-1 may acquire information related to the user and associated user computing devices 110 from one or more external sources. For example, the data engine 150-1 may acquire information from one or more social media channels (e.g., social media networks, social media sites, social media messaging systems, location information, and the like), fitness trackers, Internet of Things (IoT) devices, and so forth. Additionally, or alternatively, data engine 150-1 may retrieve results generated by various search systems. In some cases, data engine 150-1 may retrieve information corresponding to the user via the Internet from the various social media channels and/or devices discussed above.

As mentioned above, databases 116 may store information related to a current users or a previous users interactions with the organization's products and/or services. The databases 116 may be used to store information that has been gathered or tracked relating to interactions via various communication channels and devices, including in-person interactions, public network interactions, private network interactions and the like using applications on mobile devices, tablets, smart phones, mobile phones, desktops, laptops, ATMs, wearable devices, and so forth. As such, databases 116 may store information relating to users accessing an organization's services via a mobile application, a mobile browser, a desktop application, a desktop browser, a wearable device application, and so forth. In some examples, databases 116 may store metrics associated with a user's interaction with some or all web pages associated with the organization. In other examples, databases 116 may store metrics associated with a user's interaction with some or all products and/or services provided by the organization.

At 220, the data engine may aggregate data in real time or periodically (e.g., hourly, daily, weekly, and the like) from each of the different data sources. For example, the data may include user transaction information that may identify a creative activity (e.g., an art activity, a musical activity, a sporting activity, and the like). For example, the activities may include electronic data records formed, at least in part, from electronic transaction information that identifies a classification of a vendor (e.g., an art supply store, a photography store, a musical instrument store, a sporting equipment store, and the like), a venue (e.g., an entertainment venue for musical performance, an art gallery, an art museum, a sporting venue, and the like), a support organization (e.g., a foundation, a governmental organization, a writing organization, and the like). Such information may be mined from electronic transactions as payments to or from the user to the various organizations that may be the counter-party to the transaction. Additionally, the data engine 150-1 may mine external service networks (e.g., bulletin boards, social media networks, and the like) for posts associated with the users of the enterprise network that may indicate creative and/or sporting interests of the user, such as to identify posts associated with different user activities. For instance, data from social media sites may be used to understand how active a user may be in various creative activities and focus efforts to promote business formation for users that are more active in those creative activities.

At step 230, business generation and management system 104 may determine business interest for generation of a particular user business. At 240, the machine learning engine 150-2 may utilize the trained AI/ML models to generate a prioritized feature set. The prioritized feature sets may include templates that contain information regarding preferences and data for different categories of businesses. The prioritized feature sets may also include business plan information, market research data, business structure information, financial/finance information, market assessment information, and other business startup data and requirements.

At 250, the business generation and management system 104 may generate at least one business model based on the generated prioritized feature set. In step 260, machine learning engine 150-2 may facilitate generation of new business based on the generated at least one business model.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed:

1. A system comprising:
a plurality of application computing systems, each application computing system comprising a data repository storing electronic data records corresponding to electronic transactions for a plurality of users;
a computing platform, comprising:
at least one processor; and
memory storing computer-readable instructions that, when executed by the at least one processor, cause the computing platform to:
train an artificial intelligence/machine learning (AI/ML) model based on a plurality of electronic data records retrieved from the plurality of application computing systems;
determine, by the trained AI/ML model, business generation interest by a user associated with at least a portion of the plurality of electronic data records retrieved from the plurality of application computing systems;
receive approval for business model creation from the user based on the determined business generation interest;
generate a prioritized feature set based on received approval for business model creation;
generate, by a trained AI/ML model, at least one business model based on the generated prioritized feature set;
transmit the generated at least one business model to the user; and
facilitate generation of a new business based on the generated at least one business model.

2. The system of claim 1, wherein the instructions cause the computing platform to aggregate historical electronic data records from each of the plurality of application computing system.

3. The system of claim 1, wherein the new business corresponds to an identified creative interest.

4. The system of claim 1, wherein the instructions cause the computing platform to:
receive, via an application on a user device, feedback concerning the new business generation; and
retrain, based on the feedback, the AI/ML model.

5. The system of claim 1, herein the instructions cause the computing platform to:
determine advertising channels for the new business; and
generate a website for the new business.

6. The system of claim 1, herein the instructions cause the computing platform to generate and auto-populate government forms for business incorporation of the new business.

7. The system of claim 1, herein the instructions cause the computing platform to generate and open a new financial business account for the new business.

8. A method comprising:
training an artificial intelligence/machine learning (AI/ML) model based on a plurality of electronic data records retrieved from the plurality of application computing systems;
determining, by the trained AI/ML model, business generation interest by a user associated with at least a portion of the plurality of electronic data records retrieved from the plurality of application computing systems;
receiving approval for business model creation from the user based on the determined business generation interest;
generating a prioritized feature set based on received approval for business model creation;
generating, by a trained AI/ML model, at least one business model based on the generated prioritized feature set;
transmitting the generated at least one business model to the user; and
facilitating generation of a new business based on the generated at least one business model.

9. The method of claim 8, further comprising aggregating historical electronic data records from each of the plurality of application computing system.

10. The method of claim 8, wherein the new business corresponds to an identified creative interest.

11. The method of claim 8, further comprising:
receiving, via an application on a user device, feedback concerning the new business generation; and
retraining, based on the feedback, the AI/ML model.

12. The method of claim 8, further comprising:
determining advertising channels for the new business; and
generating a website for the new business.

13. The method of claim 8, further comprising generating and auto-populating government forms for business incorporation of the new business.

14. The method of claim 8, further comprising generating and opening a new financial business account for the new business.

15. Non-transitory computer readable media storing instructions that, when executed by a processor, cause a computing platform to:
train an artificial intelligence/machine learning (AI/ML) model based on a plurality of electronic data records retrieved from the plurality of application computing systems;
determine, by the trained AI/ML model, business generation interest by a user associated with at least a portion of the plurality of electronic data records retrieved from the plurality of application computing systems;
receive approval for business model creation from the user based on the determined business generation interest;
generate a prioritized feature set based on received approval for business model creation;
generate, by a trained AI/ML model, at least one business model based on the generated prioritized feature set;
transmit the generated at least one business model to the user; and
facilitate generation of a new business based on the generated at least one business model.

16. The non-transitory computer readable media of claim 15, wherein the instructions cause the computing platform to aggregate historical electronic data records from each of the plurality of application computing system.

17. The non-transitory computer readable media of claim 15, wherein the new business corresponds to an identified creative interest.

18. The non-transitory computer readable media of claim 15, wherein the instructions cause the computing platform to:
determine advertising channels for the new business; and
generate a website for the new business.

19. The non-transitory computer readable media of claim 15, wherein the instruction cause the computing platform to generate and auto-populate government forms for business incorporation of the new business.

20. The non-transitory computer readable media of claim 15, wherein the instruction cause the computing platform to generate and open a new financial business account for the new business.
